(19) United States
(12) Patent Application Publication
(10) Pub. No.: US 2025/0101743 A1
(43) Pub. Date: Mar. 27, 2025

(54) ROOFING PANEL SUPPORT AND ROOFING SYSTEM AND METHOD OF INSTALLATION

(71) Applicant: CERTAINTEED LLC, Malvern, PA (US)

(72) Inventors: Michael J. LEMBO, Souderton, PA (US); Sahas RATHI, Shrewsbury, MA (US); Yi JIANG, Shrewsbury, MA (US); Alex C. NASH, Downingtown, PA (US); Hua WANG, Northbridge, MA (US); Olivier ROSSELER, Medford, MA (US)

(21) Appl. No.: 18/728,982

(22) PCT Filed: Jan. 18, 2023
(86) PCT No.: PCT/US23/60824

§ 371 Date: Jul. 15, 2024

Related U.S. Application Data
(60) Provisional application No. 63/300,435, filed on Jan. 18, 2022.

(51) Int. Cl. E04D 3/36; E04D 12/00

(52) U.S. Cl. CPC E04D 3/36; E04D 12/004

(57) ABSTRACT

The present disclosure relates generally to roofing systems. for example. suitable for covering the roof of a house or other building. The present disclosure relates more particularly to a roofing panel support including a bracket with a support platform configured to receive a roofing panel. a first leg extending rearward from a first side of the support platform, and a second leg extending rearward from a second side of the support platform. A hook for holding the roofing panel is coupled to the bracket and disposed below the support platform. Insulation may surround the hook. Additionally. a conductive malleable strip may be positioned between the bracket and a support structure.

### TECHNICAL FIELD

The present disclosure relates generally to roofing systems, for example, suitable for covering the roof of a house or other building. The present disclosure relates more particularly to a roofing panel support configured to hold secure a roofing panel on a roof structure.

### BACKGROUND ART

Roofing systems typically include a roof surface structure formed by a roofing frame that provides the overall shape of the roof. A surface layer may then be formed over and supported by the frame. The surface layer frequently includes a decking or sheathing that is covered by one or more weather resistant layers. For example, roofs are often covered with shingles or panels that shed water and protect the roof from weather. Moving up the slope of the roof, rows of shingles or panels are placed on top of lower rows so that water may be directed away from the surface structure. Various types of shingles and panels can be secured over the surface structure, for example, by using roofing nails or a support frame.

Some roofing systems include solar elements in order to utilize solar energy that is received at the roof surface. For example, some roofing systems include solar panels secured to the roof or photovoltaic cells embedded within roofing panels. Accordingly, such roofing systems can produce electricity, which may offset energy costs and reduce the environmental impact of the structure. On the other hand, roofing systems that produce electricity may be vulnerable to electrical accidents. For example, if components of the roofing system, such as roofing panel supports, become electrically connected to a current source, they can present a danger to anything or anyone that contacts the supports.

The present inventors have determined that roofing panel supports that are configured to enhance electrical safety of the roofing system would be attractive to builders and customers.

### SUMMARY OF THE DISCLOSURE

In one aspect, the present disclosure provides a roofing panel support comprising:
a bracket including:
   a support platform with a top end and a bottom end,
   a first leg extending rearward from a first side of the support platform, the first leg including a first lower edge and a first slit extending upward into the first lower edge, and
   a second leg extending rearward from a second side of the support platform, the second leg including a second lower edge and a second slit extending upward into the second lower edge;
a first hook coupled to the bracket and disposed below the bottom end of the support platform, the first hook including an upward facing opening configured to receive a bottom edge of the roofing panel; and
a conductive malleable strip configured to be received in the first slit so as to provide an electrical connection between the bracket and a support structure.

In another aspect, the present disclosure provides a roofing panel support comprising:
a bracket including:
   a support platform with a top end and a bottom end,
   a first leg extending rearward from a first side of the support platform, and
   a second leg extending rearward from a second side of the support platform;
a metal clip secured to the bracket, the metal clip including:
   an upper portion that extends behind the support platform, and
   an exposed lower portion that extends below the bottom end of the bracket and includes a first hook with an upward facing opening configured to receive a bottom edge of the roofing panel; and
insulation surrounding the exposed lower portion of the metal clip.

In another aspect, the disclosure provides a roofing system comprising:
a surface structure of a roof;
a support structure including a first batten extending across the surface structure;
a first roofing panel support according to the disclosure secured to the first batten; and
a first roofing panel disposed on the bracket of the first roofing panel support and held by the first hook of the first roofing panel support.

Additional aspects of the disclosure will be evident from the disclosure herein.

### BRIEF DESCRIPTION OF THE DRAWINGS

The accompanying drawings are included to provide a further understanding of the methods and devices of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a schematic perspective view of a roofing panel support and support structure according to an embodiment of the disclosure;

FIG. 2 is a schematic side view of the roofing panel support and support structure of FIG. 1;

FIG. 3 is a schematic front elevation view of a roofing panel support and support structure according to an embodiment of the disclosure;

FIG. 4 is a schematic perspective view of a roofing panel support and support structure according to an embodiment of the disclosure;

FIG. 5A is a schematic perspective view of a conductive malleable sheet according to an embodiment of the disclosure;

FIG. 5B is a schematic cross-sectional side view of the conductive malleable sheet of FIG. 5A in use;

FIG. 6A is a schematic perspective view of a conductive malleable sheet according to an embodiment of the disclosure;

FIG. 6B is a schematic cross-sectional bottom view of the conductive malleable sheet of FIG. 6A in use;

FIG. 6C is a schematic cross-sectional bottom view of another conductive malleable sheet in use;

FIG. 7 is a schematic perspective view of a roofing panel support and support structure according to an embodiment of the disclosure;

FIG. 8 is a schematic perspective view of a roofing panel support and support structure according to an embodiment of the disclosure; and

FIG. 9 is a schematic front elevation view of a roofing system according to an embodiment of the disclosure.

### DETAILED DESCRIPTION OF THE PREFERRED EMBODIMENTS

As described above, the present inventors have determined that roofing panel supports that are configured to enhance electrical safety of the roofing system would be attractive to builders and customers.

Accordingly, one aspect of the disclosure is a roofing panel support including a bracket and a first hook coupled to the bracket. The bracket includes a support platform with a top end, a bottom end, a first leg extending rearward from a first side of the support platform and a second leg extending rearward from a second side of the support platform. The first leg includes a first lower edge and a first slit extending upward into the first lower edge. The second leg also includes a second lower edge and a second slit extending upward into the second lower edge. The first hook is disposed below the bottom end of the support platform and includes an upward facing opening configured to receive a bottom edge of the roofing panel. The roofing panel support also includes a conductive malleable strip configured to be received in the first slit so as to provide an electrical connection between the bracket and a support structure.

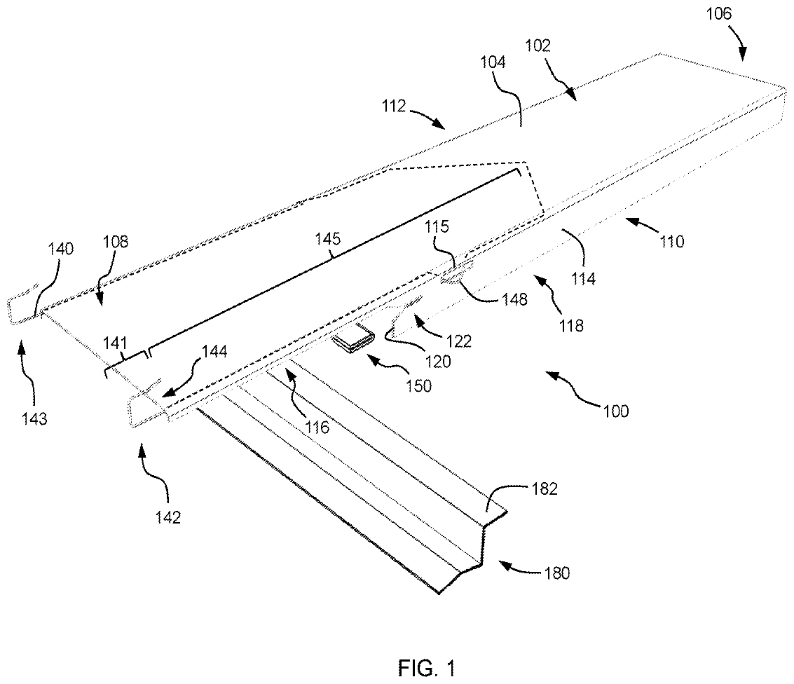

Such a roofing panel support is shown in perspective view in FIG. 1. Roofing panel support 100 includes a bracket 102 with a support platform 104 having a top end 106 and a bottom end 108. Bracket 102 also includes a first side 110 and a second side 112. Extending rearward from first side 110 of bracket 102 is a first leg 114 that runs the length of bracket 102 from the top end 106 to the bottom end 108. First leg 114 includes a short lower section 116 and a deeper upper section 118 that extends further back from support platform 104 than lower section 116. First leg 114 transitions from the upper section 118 to the lower section 116 along a lower edge 120 that faces toward bottom end 108. First leg 114 also includes a first slit 122 that extends upward into lower edge 120. First slit 122 is configured to receive part of a support structure in order to secure roofing panel support 100 to the support structure. For example, FIG. 1 shows a batten 180 that includes a flange 182 configured to be inserted into first slit 122 so that bracket 102 is held firmly on batten 180. Bracket 102 also includes a second leg with a similar configuration to first leg 114 that also includes a slit for receiving the batten 180.

The terms top and bottom, as well as upper and lower, as used herein, refer to a direction that is along the slope of the overall roofing structure and the individual roofing panels. In contrast, the directions perpendicular to the roofing structure are referred to herein as front and rear. Thus, a front surface may be exposed while the corresponding rear surface may face the support structure of the roof.

In addition to bracket 102, roofing panel support 100 also includes a first hook 142 disposed below the bottom end 108 of support platform 104. First hook 142 is positioned at the first side 110 of bracket 102 and includes an upward facing opening 144 configured to receive a bottom edge of a roofing panel. First hook 142 is secured to bracket 102 such that the weight of a roofing panel held in first hook 142 will be transmitted from first hook 142, through bracket 102 to batten 180 of the support structure. A similarly configured second hook 143 is positioned at the second side 112 of bracket 102 and is also configured to receive the bottom edge of a roofing panel.

Roofing panel support 100 also includes a conductive malleable strip 150 configured to be received in first slit 122 and in contact with the batten 180. For illustration, the conductive malleable strip 150 is shown between batten 180 and first slit 122 prior to insertion of batten 180 into first slit 122. The interior surface of first slit 122 is electrically conductive. Accordingly, the placement of conductive malleable strip 150 within first slit 122 can help provide an electrical connection between bracket 102 and batten 180. This allows bracket 102 and batten 180 to be electrically bonded to one another via conductive malleable strip 150. By electrically bonding bracket 102 and batten 180, these components have the same electrical potential and current can freely pass from one to the other. Moreover, the bracket 102, batten 180, and any other components they are electrically bonded to can be collectively connected to an electrical ground so as to electrically ground the entire supporting structure. Accordingly, current can be dissipated to the electrical ground in the event of an electrical fault or surge, a lighting strike or an accidental short circuit.

The conductive malleable strip may also aid the structural connection between the bracket and the batten. Because the conductive malleable strip can conform to the shape of the bracket and/or batten, the conductive malleable strip can be pushed into the slit of the bracket even when the thickness of the combination of the batten and conductive malleable strip is slightly greater than the opening of the slit. This can simplify manufacturing, as it may allow for the dimensional tolerance of the batten thickness or slit opening width to be reduced.

The term malleable, as used herein, refers to the ability of the conductive malleable strip to conform to the shape of the first slit when pressed between the material of the bracket and the connected component of the support structure. The conductive malleable strip may also be referred to as pliable, ductile, pliant, soft, workable, flexible, or adaptable. For example, in some embodiments, the conductive malleable strip is formed of a softer material than the bracket. Thus, when the conductive malleable strip is pressed against the bracket, the conductive malleable strip may deform in order to conform to the shape of the bracket. For instance, in some embodiments, the material of the conductive malleable strip has a lower grade on the Mohs scale than the material of the bracket. For example, in some embodiments, the material of the conductive malleable strip is at least one grade lower on the Mohs scale than the material of the bracket. Accordingly, when the bracket and conductive malleable strip are pressed together, the bracket will substantially hold its shape while the conductive malleable strip will deform if it is formed of a softer material.

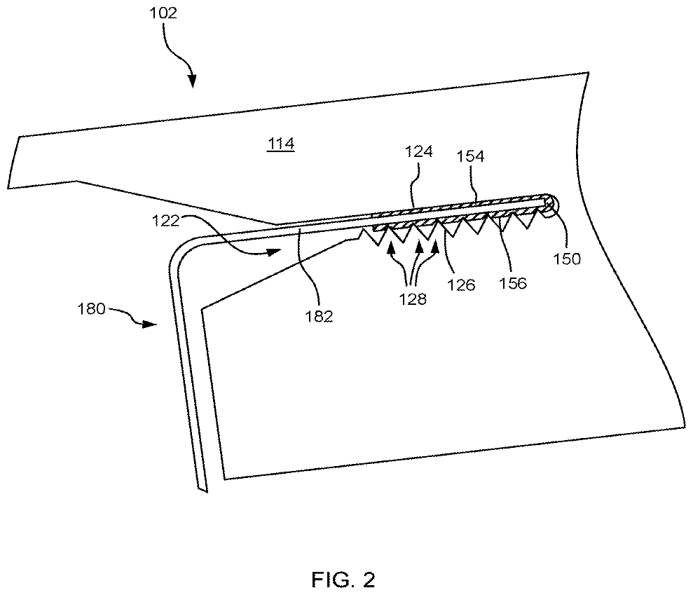

FIG. 2 shows a detailed side view of a portion of bracket 102 around slit 122 and illustrates the connection between the inner edge of slit 122, conductive malleable strip 150, and flange 182 of batten 180. As shown, slit 122 extends upward from lower edge 120 and the upwardly extending flange 182 is inserted into slit 122. Likewise, conductive malleable strip 150 is also positioned within slit 122 and provides an electrical connection between bracket 102 and the flange 182 of batten 180.

In certain embodiments of the roofing panel support as otherwise described herein, an outer surface of the bracket is conductive. For example, in some embodiments, the entire bracket is conductive, such that the bracket is capable of conducting electricity through the interior of the bracket and is able to receive or discharge current through its outer surface. In view of the conductivity of the outer surface of such a bracket, if an object with an electrical charge contacts the surface of the bracket, current may flow through the bracket. In other embodiments, the surface of the bracket includes a treatment or coating that limits the conductivity of the outer surface. For example, in some embodiments, most of the outer surface of the bracket is insulated. In such a case, a conductive interior of the bracket may be exposed along the edge of the slit. Accordingly, when the slit receives the conductive malleable strip and the support structure, an electrical connection can be achieved despite the insulated outer exterior of most of the bracket.

In some embodiments, the material of the conductive malleable strip has a similar anodic index as the material of the bracket. As will be known to one skilled in the art, there may be advantages in having the conductive malleable strip and materials that it contacts have a low difference in anodic index. For example, in some embodiments, the conductive malleable strip has an anodic index that differs from the anodic index of the bracket by no more than 0.60V, e.g., no more than 0.50V, e.g., no more than 0.45V. Further, it has been found that the potential for galvanic action, which may result in rusting and other undesirable conditions, may be reduced by further similarity between the anodic index of the material of the conductive malleable strip and materials it contacts. Accordingly, in some embodiments, the conductive malleable strip has an anodic index that differs from the anodic index of the bracket by no more than 0.40V, e.g., no more than 0.35V, e.g., no more than 0.30V. Further, in some embodiments, the conductive malleable strip and other materials it contacts, such as the material of the hook, as described further below, has a difference in anodic index of no more than 0.60V, e.g., no more than 0.50V, e.g., no more than 0.40V, e.g., no more than 0.35V. e.g., no more than 0.30V. For example, in some embodiments, the conductive malleable strip incudes a material comprising aluminum, tin or lead.

In certain embodiments of the roofing panel support as otherwise described herein, an edge of the first slit includes a row of teeth. For example, as shown in FIG. 2, rear edge 126 of slit 122 includes a row of teeth 128 formed as sharp projections that extend into the interior of slit 122. The sharp configuration of teeth 128 help promote a strong electrical connection between bracket 102 and conductive malleable strip 150, as the teeth bite into the surface of conductive malleable strip 150 thereby penetrating the conductive material.

Further, in some embodiments, the teeth may be configured to scratch the surface of the support structure directly, such as a flange extending into the slit. For example, in some embodiments, the teeth penetrate entirely through the conductive malleable strip to engage the flange. In other embodiments, the conductive malleable strip is disposed only on an opposite side of the flange as the teeth, such that the conductive malleable strip promotes a strong connection on one side of the flange and the teeth promote a strong connection on the other.

While slit 122 of bracket 102 includes teeth on the rear edge 126 of slit 122, in other embodiments, the slit includes teeth on the front edge. Furthermore, in some embodiments, the slit includes teeth on both the front and rear edges.

In certain embodiments of the roofing panel support as otherwise described herein, the conductive malleable strip includes a folded structure with a front flap and a rear flap, and the conductive malleable strip is configured to surround a flange of the support structure such that the front flap is positioned against a front edge of the first slit and the rear flap is positioned against a rear edge of the first slit. For example, as shown in FIG. 2, conductive malleable strip 150 has a folded structure including a front flap 154 disposed between the front edge 124 of slit 122 and flange 182 of batten 180. A rear flap 156 is attached to front flap 154 by a bend so as to form a folded structure of conductive malleable strip 150. Rear flap 156 is positioned between rear edge 126 of slit 122 and flange 182, such that the teeth 128 of rear edge 126 bite into rear flap 156. The folded structure of conductive malleable strip 150 allows the strip to aid the electrical connection between batten 180 and bracket 102 on both the front and rear sides of flange 182 of batten 180.

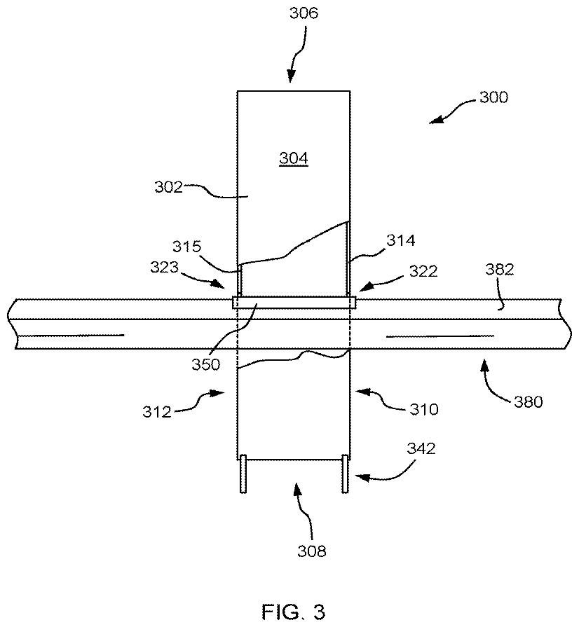

In certain embodiments of the roofing panel support as otherwise described herein, the conductive malleable strip is configured to extend to the second slit of the second leg. A front elevation view of such a roofing panel support is shown in FIG. 3. Roofing panel support 300 includes a bracket 302 with a top end 306, a bottom end 308, a first side 310 and a second side 312. A first hook 342 is disposed below the bottom end 308 of bracket 302 and is configured to hold up a roofing panel resting on bracket 302. In particular, bracket 302 includes a support platform 304 that is configured to receive the roofing panel. A portion of support platform 304 is cut away to more clearly show a rear part of a first leg 314 and a second leg 315 of bracket 302.

Each of the first leg 314 and second leg 315 includes a respective slit 322, 323 that receives a flange 382 of a batten 380 such that bracket 302 is secured to batten 380. To enhance the structural and electrical connection between bracket 302 and batten 380, a conductive malleable strip 350 is positioned between flange 382 of batten 380 and the respective edges of first slit 322 and second slit 323. In particular, conductive malleable strip 350 has a sufficient width to extend from first slit 322 to second slit 323.

In other embodiments, the width of the conductive malleable strip is configured to be placed within the slit of only one leg of the bracket. For example, in some embodiments, a conductive malleable strip that is inserted into the slit of a single leg of the bracket provides sufficient electrical and structural connection between the bracket and the batten. In other embodiments, a pair of conductive malleable strips are used such that the slit of each leg is engaged by a separate conductive malleable strip.

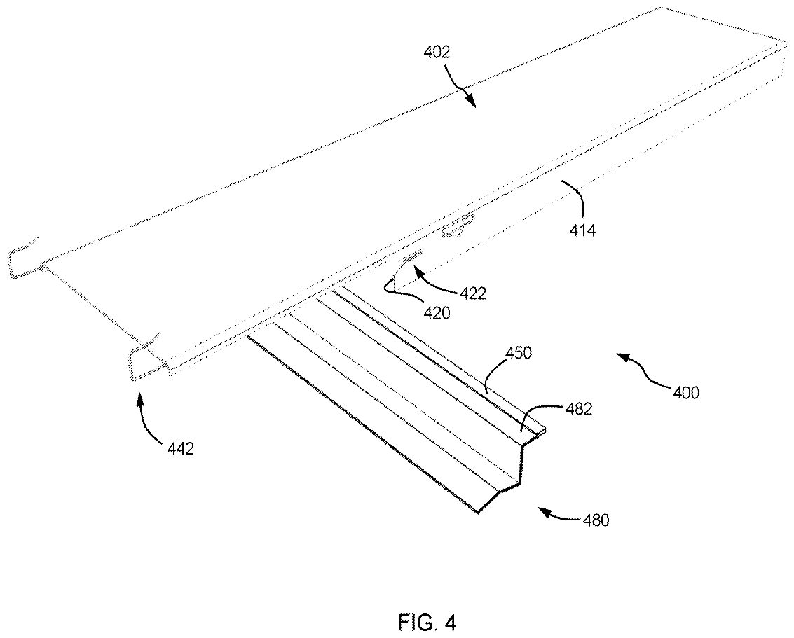

In certain embodiments of the roofing panel support as otherwise described herein, the conductive malleable strip is plated on a flange of a batten. Such a roofing panel support is shown in FIG. 4. Roofing panel support 400 includes a bracket 402 and a hook 442 extending below a bottom end of bracket 402. Bracket 402 includes a first leg 414 with a slit 422 formed in a lower edge 420 of the leg. A batten 480 is configured to engage slit 422 and includes a flange 482 that is sized to fit between the edges of slit 422. A conductive malleable strip 450 is plated onto a front surface of flange 482 so as to provide strong structural and electrical contact between conductive malleable strip 450 and batten 480. When flange 482 is inserted into slit 422, the conductive malleable strip 450 is configured to conform to the shape of bracket 402, which provides a similarly strong connection between conductive malleable strip 450 and bracket 402.

In certain embodiments of the roofing panel support as otherwise described herein, the first hook is formed by a metal clip secured to the bracket. The metal clip includes an upper portion that extends behind the support platform, and an exposed lower portion that extends below the bottom end of the bracket and includes the first hook. For example, as shown in FIG. 1, first hook 142 of roofing panel support 100 is formed by a wire metal clip 140 that includes a lower portion 141 extending down from the bottom end 108 of bracket 102. An upper portion 145 of metal clip 140 extends upward behind support platform 104 and is shown in FIG. 1 using dashed lines. First hook 142 is part of the exposed lower portion 141 that is not shielded behind support platform 104.

The use of a wire metal clip to form the first hook allows provides a thin strong structure to support a roofing panel that is easily connected to the bracket. In view of the relatively small size of the wire metal clip, the first hook can support the roofing panel without being visually obtrusive within the aesthetic of the roofing structure. In other embodiments, the hook is formed by a cast, molded, carved or printed component, or a bent sheet, such as a bent metal sheet. Further still, in some embodiments, the hook is integrally formed with the bracket in a single piece of material.

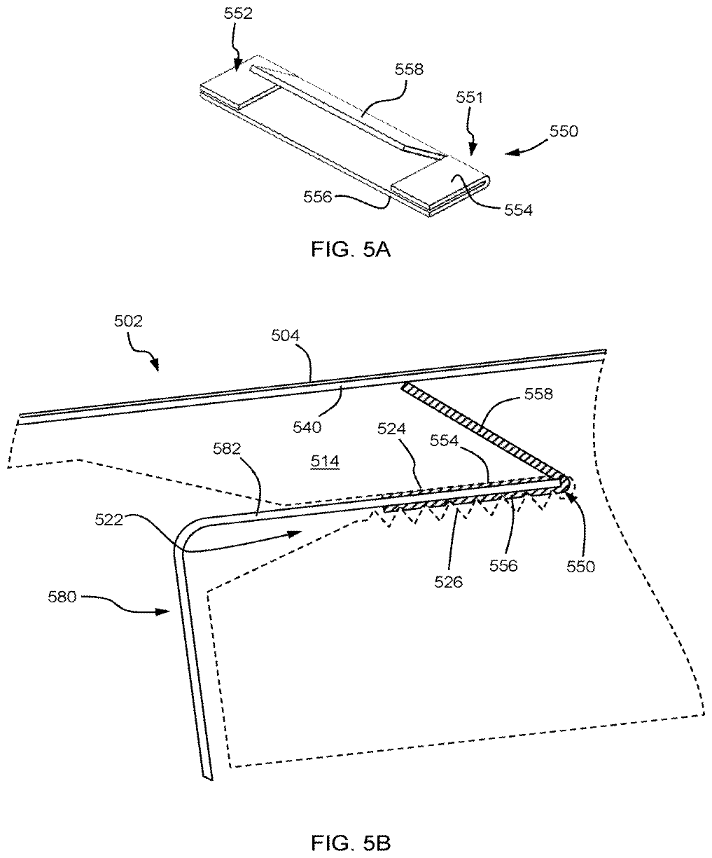

In certain embodiments of the roofing panel support as otherwise described herein, the conductive malleable strip includes a forward extension configured to contact the metal clip. FIGS. 5A illustrates such a conductive malleable strip. Conductive malleable strip 550 is configured to extend from a slit in the first leg of a bracket to the slit in a second leg of the bracket. Conductive malleable strip 550 has a folded structure that includes a rear flap 556 extending across the entire width of the strip and a front flap 554 formed in two sections 551. 552. The first section 551 of front flap 554 is configured to contact one leg of the bracket while the second section 552 is configured to contact the other leg of the bracket. Between the first section 551 and second section 552 of front flap 554, conductive malleable strip 550 includes a forward extension 558 configured to engage a metal clip that forms the first hook of the roofing panel support.

FIG. 5B illustrates a cross-sectional side view of part of a roofing panel system that includes conductive malleable strip 550. As shown, the roofing panel system includes a bracket 502 that is secured to a flange 582 of a batten 580 by the insertion of the flange 582 within the first slit 522 of the first leg 514 of bracket 502. An outline of a portion of first leg 514 of bracket 502 is shown using dashed lines so that components behind first leg 514 are visible. The conductive malleable strip 550 is positioned to surround flange 582 with the rear flap 556 positioned behind flange 582 and the front flap 554 positioned in front of flange 582. Accordingly, rear flap 556 is interposed between flange 582 and the rear edge 526 of slit 522 while front flap 554 is interposed between the flange 582 and the front edge 524 of slit 522, thereby forming a structural and electrical connection between the batten 580 and bracket 502. Forward extension 558 extends toward support platform 504 and contacts metal clip 540. Accordingly, an electrical connection can also be established between batten 580 and metal clip 540.

In certain embodiments of the roofing panel support as otherwise described herein, the forward extension is formed as a tab that abuts the metal clip. For example, forward extension 558 of conductive malleable strip 550 is formed as a tab that extends outward from the upper edge of rear flap 556.

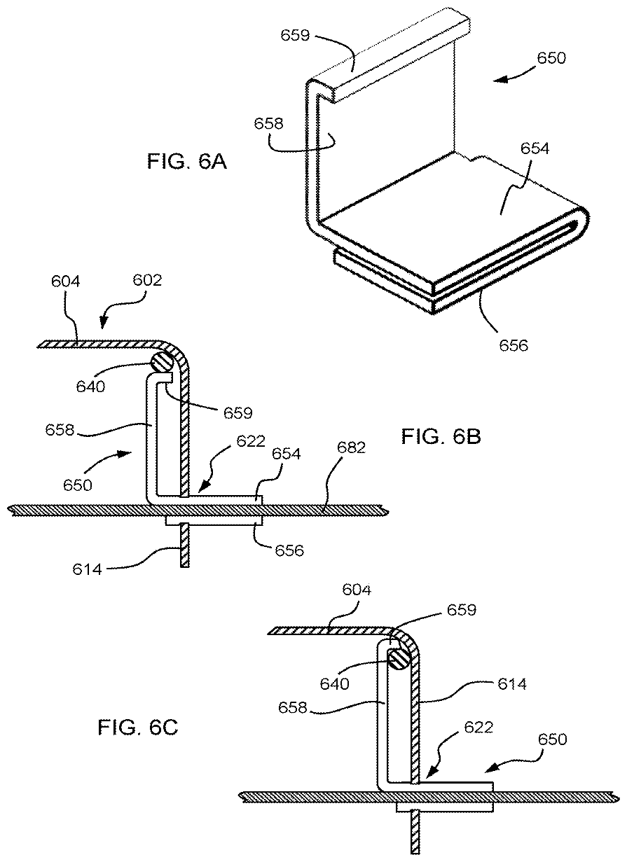

In other embodiments, the forward extension of the conductive malleable strip includes a lateral projection that contacts the metal clip. Such a conductive malleable strip is shown in FIGS. 6A-6C. Conductive malleable strip 650 has a folded structure that includes a rear flap 656 and a front flap 654 that are configured to surround a flange of a support structure and fit within a slit of a bracket. Conductive malleable strip 650 also includes a forward extension 658 configured to engage a metal clip that forms the first hook of the roofing panel support. In particular, forward extension 658 includes a lateral projection 659 that is configured to contact the metal clip.

FIG. 6B illustrates a cross-sectional bottom view of part of a roofing panel system that includes conductive malleable strip 650. As shown, the roofing panel system includes a bracket 602 including a support platform 604 and first leg 614. A flange 682 of a batten is received in a slit 622 in the first leg 614. The conductive malleable strip 650 is positioned to surround flange 682 with the rear flap 656 positioned behind flange 682 and the front flap 654 positioned in front of flange 682, thereby forming a structural and electrical connection between the batten and bracket 602. Forward extension 658 projects toward support platform 604 and includes a lateral projection 659 extending toward first leg 614. The lateral projection 659 extends along metal clip 640 making contact with the metal clip 640. Accordingly, an electrical connection can also be established between the batten and metal clip 640.

FIG. 6C illustrates a cross-sectional bottom view of part of a roofing panel system having a similar configuration to FIG. 6B. As shown, the conductive malleable strip 650 is again positioned to surround flange 682 and be inserted into the slit 622 in first leg 614. Forward extension 658 of conductive malleable strip 650 projects toward support platform 604 and includes a lateral projection 659 that extends around metal clip 640 so as to partially surround metal clip 640. The lateral projection 659 extends along metal clip 640 making contact with the metal clip 640. Such a configuration can provide additional contact between the conductive malleable strip 650 and metal clip 640.

In another aspect, the disclosure provides a roofing panel support including a bracket and a metal clip secured the bracket. The bracket includes a support platform with a top end and a bottom end, a first leg extending rearward from a first side of the support platform, and a second leg extending rearward from a second side of the support platform. The metal clip includes an upper portion that extends behind the support platform, and an exposed lower portion that extends below the bottom end of the bracket. The exposed lower portion includes a first hook with an upward facing opening configured to receive a bottom edge of the roofing panel. The roofing panel support also includes insulation surrounding the exposed lower portion of the metal clip.

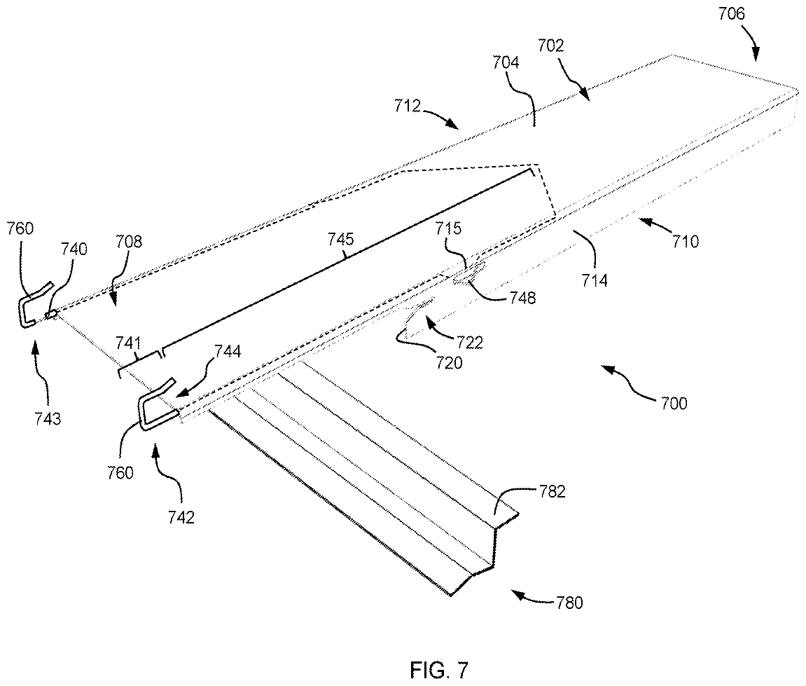

Such a roofing panel support is shown in FIG. 7. Roofing panel support 700 includes a bracket 702 with a support platform 704 having a top end 706 and a bottom end 708. Bracket 702 also includes a first side 710 and a second side 712. Extending rearward from first side 710 of bracket 702 is a first leg 714 that runs the length of bracket 702 from the top end 706 to the bottom end 708. Bracket 702 also includes a second leg with a similar configuration to first leg 714 that also includes a slit for receiving the batten 780.

In addition to bracket 702, roofing panel support 700 also includes a wire metal clip 740 coupled to bracket 702. Metal clip 740 includes an exposed lower portion 741 that extends below the bottom end 708 of bracket 702 and an upper portion 745 that is positioned behind support platform 704 of bracket 702. Exposed lower portion 741 includes a first hook 742 with an upwardly extending opening 744 configured to hold a roofing panel. Lower portion 741 also includes a similarly configured second hook 743 that further helps support the roofing panel. Roofing panel support 700 also includes insulation 760 surrounding lower portion 741 of metal clip 740, including first hook 742 and second hook 743. A small section of insulation 760 is cut away from second hook 743 to show the material of metal clip 740.

When a roofing system using roofing panel support 700 is fully installed, a roofing panel is placed in front of support platform 704 of bracket 702 and obscures most of roofing panel support 700. However, part of the lower portion 741 of metal clip 740 extends around the lower edge to the front of the roofing panel, where it is both visible and accessible. Adding insulation 760 over this exposed portion of metal clip 740 provides electrical protection against electrical discharges through the metal clip 740. The insulation may also help meet certain regulations that require any exposed metal of a solar roofing systems to be grounded. Insulating parts of the metal clip may obviate the need to ground the metal clip, as these parts may not be considered to be exposed.

In certain embodiments of the roofing panel support as otherwise described herein, an outer surface of the bracket is conductive. For example, in some embodiments, the bracket is entirely made of a conductive material. Despite both the bracket and metal clip being conductive in such an embodiment, sufficiently electrically bonding the metal clip to the bracket may be difficult. By including insulation over the exposed portion of the metal clip, the need to ground the metal clip may be avoided. Moreover, because the bracket is positioned behind the roofing panel and not exposed, it may not need to be insulated.

Similar to roofing panel support 100, shown in FIGS. 1 and 2, the first leg 714 of bracket 702 includes a first lower edge 720 and a first slit 722 extending upward into the first lower edge 720. Likewise, the second leg may have a similar configuration. The first slit 722 of bracket 702 can be utilized to receive a flange 782 of a batten 780 in order to connect the roofing panel support 700 to batten 780. Alternatively, in some embodiments, the legs of the bracket may include feet for securing the bracket directly to a surface structure.

In certain embodiments of the roofing panel support as otherwise described herein, the bracket is formed of a metal material. For example, in some embodiments, the bracket is formed of aluminum, galvanized steel, galvalume, or another material. Further, in some embodiments, the bracket is formed by a bent metal sheet. For example, bracket 102 of roofing panel support 100 shown in FIG. 1 is formed by a cut and bent metal sheet, where the first leg 114 is formed by a section of a metal sheet that is bent rearward from the support platform 104 along the first side 110 of bracket 102. The second leg may similarly be formed by a section of the metal sheet that is bent along the second side 112. Similarly, bracket 702 of roofing panel support 700 shown in FIG. 7, is formed by a bent metal sheet where the first leg 714 and the second leg are bent rearward from the support platform 704.

In other embodiments, the bracket may be formed by molding, casting, extruding or another method. Further still, in some embodiments, the bracket is formed of a non-metallic material, such as plastic or wood.

In certain embodiments of the roofing panel support as otherwise described herein, the first hook and the second hook are formed at opposing ends of the metal clip. For example, as shown in FIG. 1, first hook 142 is formed at a first end of metal clip 140 while a second hook 143 is formed at a second end of metal clip 140. First hook 142 and second hook 143 cooperate to hold a roofing panel in two locations at the same elevation, providing a stable support for the roofing panel. From each hook 142, 143, metal clip 140 extends upward behind support platform 104 toward top end 106 of bracket 102. Accordingly, metal clip 140 has a substantially U-shaped configuration. As shown in FIG. 7, metal clip 740 of roofing panel support 700 has a similar configuration, where first hook 742 and second hook 743 are formed at opposing ends of metal clip 740. Likewise, a middle section of metal clip 740 extends upward behind support platform 704 and is secured to bracket 702.

In certain embodiments of the roofing panel support as otherwise described herein, the metal clip is formed by a bent wire. Such a bent wire can provide strong hooks at the bottom of the roofing panel support while allowing for simple fabrication. In other embodiments, the metal clip may be formed of a bent sheet or rail. Still, in other embodiments, the metal clip may be a molded, cast or extruded component.

In certain embodiments of the roofing panel support as otherwise described herein, the first leg of the bracket includes an aperture and the metal clip includes a projection that extends through the aperture in the first leg so as to secure the metal clip to the bracket. For example, as shown in FIG. 1, first leg 114 of bracket 102 includes an aperture 115 above slit 122 and near support platform 104. To couple metal clip 140 to bracket 102, upper portion 145 of metal clip 140 includes an outward projection 148 formed by three bends in the metal wire that is inserted through aperture 115. In order to insert the projection 148 through aperture 115, the two hooks 142, 143 can be brought together so that the entirety of metal clip 140 fits behind support platform 104 and between the first leg 114 and the second leg of bracket 102. The hooks 142, 143 may then be released so that projection 148 extends through aperture 115. Wire clip 740 of roofing panel support 700 has a similar configuration with a projection 748 that extends through an aperture 715 in first leg 714, as shown in FIG. 7.

In some embodiments, the projection is surrounded by insulation. For example, in some embodiments, a sleeve of insulation is provided over the projection. In other embodiments, the projection is coated with insulation. Alternatively, in some embodiments, the metal surface of the projection is left uncovered.

In certain embodiments of the roofing panel support as otherwise described herein, the insulation surrounds the entire metal clip. For example, in some embodiments, the metal clip is entirely coated or surrounded by insulation. On the other hand, in other embodiments, at least a portion of the metal clip is left uncovered. Further, in some embodiments, at least a portion of the metal clip directly contacts the bracket. For example, in some embodiments, sections of the surface of the metal clip directly contact the surface of the bracket. Still, despite such contact between the metal clip and bracket, in some embodiment exposed portions of the metal clip are covered by the insulation to avoid electrical accidents with the metal clip. Alternatively, in some embodiments, the metal clip is isolated from the bracket.

In certain embodiments of the roofing panel support as otherwise described herein, the insulation is formed as coating that is adhered to a surface of the metal clip. In other embodiments, the insulation is formed as one or more sleeves that slips over a section of the metal clip. For example, in some embodiments, the insulation is formed as a closed tube that slips over the end of the metal clip. Further still, in some embodiments, the insulation is formed by one or more sections of coating and one or more sleeves.

In certain embodiments of the roofing panel support as otherwise described herein, the insulation includes at least one of silicone, PVDF, PTFE and PVC. Other materials for the insulation are also possible. Such materials will have good electrical isolating properties. Good electrical insulators may be understood by one skilled in the art to have an insulation resistance value of at least 10 Megohm (e.g., at least 20 Megohm, at least 50 Megohm, at least 100 Megohm, etc.). Other such insulating materials may include ceramic or porcelain, glass, nylon, rubber, PFA (Perfluoroalkoxy) or paper.

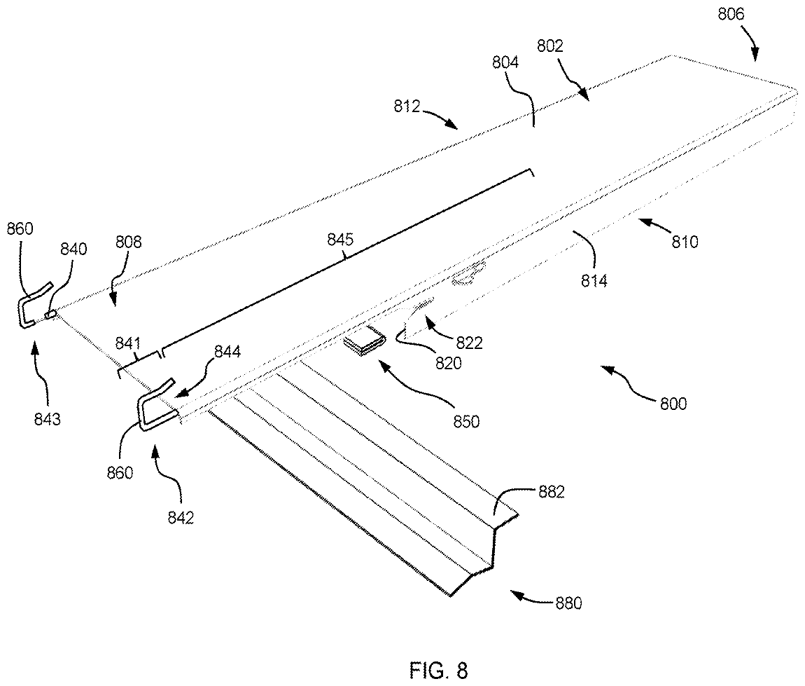

In some embodiments, the roofing panel support includes both a conductive malleable strip and insulation covering an exposed lower portion of a metal clip. Such a roofing panel support is shown in FIG. 8. Roofing panel support 800 includes a bracket 802 with a support platform 804 having a top end 806 and a bottom end 808. Bracket 802 also includes a first side 810 and a second side 812. Extending rearward from first side 810 of bracket 802 is a first leg 814 that runs the length of bracket 802 from the top end 806 to the bottom end 808. First leg 814 includes a first slit 822 that extends upward into a lower edge 820. First slit 822 is configured to receive part of a support structure in order to secure roofing panel support 800 to the support structure. For example, FIG. 8 shows a batten 880 that includes a flange 882 configured to be inserted into first slit 822 so that bracket 802 is held firmly on batten 880. Bracket 802 also includes a second leg with a similar configuration to first leg 814 that also includes a slit for receiving the batten 880.

In addition to bracket 802, roofing panel support 800 also includes a wire metal clip 840 coupled to bracket 802. Metal clip 840 includes an exposed lower portion 841 that extends below the bottom end 808 of bracket 802 and an upper portion 845 that is positioned behind support platform 804 of bracket 802. Exposed lower portion 841 includes a first hook 842 with an upwardly extending opening 844 configured to hold a roofing panel. Lower portion 841 also includes a similarly configured second hook 843 that further helps support the roofing panel. Roofing panel support 800 also includes insulation 860 surrounding lower portion 841 of metal clip 840, including first hook 842 and second hook 843. A small section of insulation 860 is cut away from second hook 843 to show the material of metal clip 840.

Roofing panel support 800 also includes a conductive malleable strip 850 configured to be received in first slit 822 and in contact with the batten 880. For illustration, the conductive malleable strip 850 is shown between batten 880 and first slit 822 prior to insertion of batten 880 into first slit 822.

In another aspect, the present disclosure provides a roofing system including a surface structure of a roof and a support structure disposed on the surface structure. The support structure includes a first batten that extends across the surface structure. A first roofing panel support according to the disclosure is secured to the first batten. The roofing system also includes a first roofing panel disposed on the bracket of the first roofing panel and held by the first hook of the first roofing panel support.

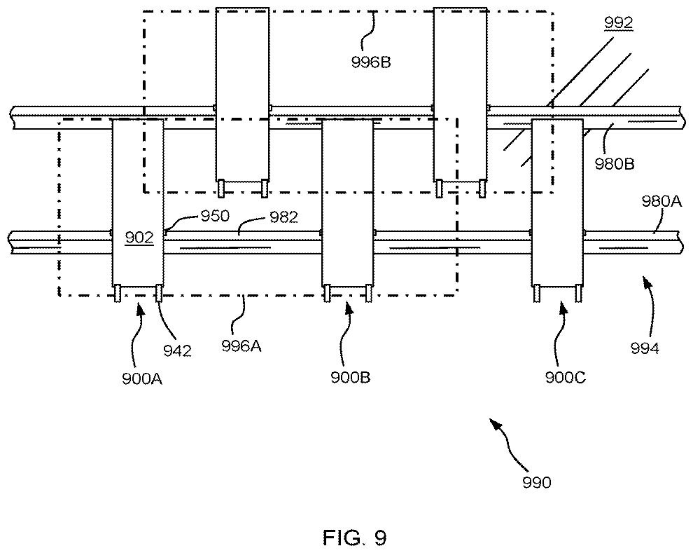

Such a roofing system is shown in FIG. 9. Roofing system 990 includes a surface structure 992 that may be formed by a decking or sheathing that is covered by one or more weather resistant layers and supported by a frame. A support structure 994 is secured to surface structure 992 and includes a first batten 980A extending across the surface structure 992. In some embodiments, the battens of the support structure are secured directly to the surface structure. In other embodiments the support structure includes riser blocks or other components that space the battens from the surface structure to provide a space for moisture draining, wire routing, or for accommodating electrical components.

Roofing system 990 also includes a first roofing panel support 900A that is secured to first batten 980A and supports a first roofing panel 996A. In particular a first hook 942 of first roofing panel support 900A holds up the first roofing panel 996A. First roofing panel 996A is illustrated with a dashed line so that other components of roofing system 990 are not hidden.

In certain embodiments of the roofing system as otherwise described herein, the first batten includes an upwardly extending flange that is received in a first slit in the first leg of the bracket of the first roofing panel support, and a conductive malleable strip is interposed between the flange of the first batten and an edge of the first slit. For example, first batten 980A includes an upwardly extending flange 982 that is partially surrounded by a conductive malleable strip 950. The conductive malleable strip 950 and flange 982 are inserted into the slit in bracket 902 in a manner similar to that shown in FIGS. 1 and 2.

In certain embodiments of the roofing system as otherwise described herein, the first roofing panel support is one of a plurality of roofing panel supports secured along the first batten. For example, as shown in FIG. 9, roofing system includes several roofing panel supports 900A-900C disposed along first batten 980A. Accordingly, roofing system 990 can accommodate a row, or course, of roofing panels across first batten 980A.

In certain embodiments of the roofing system as otherwise described herein, the roofing system also includes a second batten disposed above the first batten. For example, in some embodiments, the roofing system includes several battens that are spaced apart over the slope of the roof so as to support several courses of roofing panels. As an example, roofing system 990 includes a second batten 980B that is positioned above first batten 980A.

In certain embodiments of the roofing system as otherwise described herein, a top end of the first roofing panel support is supported by the second batten. For example, as shown in FIG. 9, a top end of first roofing panel support 900A is position to rest on a lower section of second batten 980B. Accordingly, first batten 980A and second batten 980B cooperate to support first roofing panel support 900A.

In some embodiments, a bottom end of the second roofing panel support overlaps the first roofing panel. For example, as shown in FIG. 9, the bottom end of second roofing panel support 900B overlaps first roofing panel 996A. This allows a second roofing panel 996B to be held by second roofing panel support 900B in a position that overlaps first roofing panel 996A. Accordingly, rain and moisture can flow down from second roofing panel 996B onto the surface of first roofing panel 996A.

In certain embodiments of the roofing system as otherwise described herein, the roofing panels include solar roofing panels. For example, in some embodiments, each of a group of the roofing panels includes a panel body and photovoltaic elements disposed in the panel body. For example, in some embodiments, the roofing panels include a glass panel body that incorporates photovoltaic elements. In other embodiments, the panel body is formed of a variety of materials.

In other embodiments of the roofing assembly as otherwise described herein, the roofing panels include non-solar roofing panels. For example, in some embodiments, at least some of the roofing panels are standard roofing panels without any electrical activity or connections. Further, in some embodiments, the roofing panels are formed of glass, metal, ceramic or a polymer material.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A roofing panel support comprising: a bracket including: a support platform with a top end and a bottom end, a first leg extending rearward from a first side of the support platform, the first leg including a first lower edge and a first slit extending upward into the first lower edge, and a second leg extending rearward from a second side of the support platform, the second leg including a second lower edge and a second slit extending upward into the second lower edge; a first hook coupled to the bracket and disposed below the bottom end of the support platform, the first hook including an upward facing opening configured to receive a bottom edge of the roofing panel; and a conductive malleable strip configured to be received in the first slit so as to provide an electrical connection between the bracket and a support structure.

Embodiment 2. The roofing panel support according to embodiment 1, wherein an outer surface of the bracket is conductive.

Embodiment 3. The roofing panel support according to embodiment 2, wherein the bracket is formed of a metal material.

Embodiment 4. The roofing panel support according to embodiment 3, wherein the bracket is formed by a bent metal sheet.

Embodiment 5. The roofing panel support according to any one of embodiments 1 to 4, wherein the conductive malleable strip is formed of a softer material than the bracket.

Embodiment 6. The roofing panel support according to embodiment 5, wherein the conductive malleable strip is formed of a material comprising aluminum, tin or lead.

Embodiment 7. The roofing panel support according to any one of embodiments 1 to 6, wherein an edge of the first slit includes a row of teeth.

Embodiment 8. The roofing panel support according to any one of embodiments 1 to 7, wherein the conductive malleable strip includes a folded structure with a front flap and a rear flap, and wherein the conductive malleable strip is configured to surround a flange of the support structure such that the front flap is positioned against a front edge of the first slit and the rear flap is positioned against a rear edge of the first slit.

Embodiment 9. The roofing panel support according to any one of embodiments 1 to 7, wherein the conductive malleable strip is plated on a flange of a batten.

Embodiment 10. The roofing panel support according to any one of embodiments 1 to 9, wherein the conductive malleable strip is configured to extend to the second slit of the second leg.

Embodiment 11. The roofing panel support according to any one of embodiments 1 to 10, wherein the first hook is formed by a metal clip secured to the bracket, the metal clip including: an upper portion that extends behind the support platform, and an exposed lower portion that extends below the bottom end of the bracket and includes the first hook.

Embodiment 12. The roofing panel support according to embodiment 11, further comprising insulation surrounding the exposed lower portion of the metal clip.

Embodiment 13. The roofing panel support according to embodiment 11 or 12, wherein the conductive malleable strip includes a forward extension configured to contact the metal clip.

Embodiment 14. The roofing panel support according to embodiment 13, wherein the forward extension is formed as a tab that abuts the metal clip.

Embodiment 15. The roofing panel support according to embodiment 13, wherein the forward extension includes a lateral projection that contacts the metal clip.

Embodiment 16. A roofing panel support comprising: a bracket including: a support platform with a top end and a bottom end, a first leg extending rearward from a first side of the support platform, and a second leg extending rearward from a second side of the support platform; a metal clip secured to the bracket, the metal clip including: an upper portion that extends behind the support platform, and an exposed lower portion that extends below the bottom end of the bracket and includes a first hook with an upward facing opening configured to receive a bottom edge of the roofing panel; and insulation surrounding the exposed lower portion of the metal clip.

Embodiment 17. The roofing panel support according to embodiment 16, wherein an outer surface of the bracket is conductive.

Embodiment 18. The roofing panel support according to embodiment 17, wherein the bracket is formed of a metal material.

Embodiment 19. The roofing panel support according to embodiment 18, wherein the bracket is formed by a bent metal sheet.

Embodiment 20. The roofing panel support according to any one of embodiments 16 to 19, wherein the first leg includes a first lower edge and a first slit extending upward into the first lower edge, and wherein the second leg includes a second lower edge and a second slit extending upward into the second lower edge.

Embodiment 21. The roofing panel support according to any one of embodiments 11 to 20, wherein the exposed lower portion of the metal clip includes a second hook with an upward facing opening configured to receive the bottom edge of the roofing panel.

Embodiment 22. The roofing panel support according to embodiment 21, wherein the first hook and the second hook are formed at opposing ends of the metal clip.

Embodiment 23. The roofing panel support according to any one of embodiments 11 to 22, wherein the metal clip is formed by a bent wire.

Embodiment 24. The roofing panel support according to any one of embodiments 11 to 22, wherein the first leg of the bracket includes an aperture, and wherein the metal clip includes a projection that extends through the aperture in the first leg so as to secure the metal clip to the bracket.

Embodiment 25. The roofing panel support according to embodiment 24, wherein the projection is surrounded by insulation.

Embodiment 26. The roofing panel support according to any one of embodiments 11 to 25, wherein a portion of the metal clip directly contacts the bracket.

Embodiment 27. The roofing panel support according to any one of embodiments 12 to 26, wherein the insulation surrounds the entire metal clip.

Embodiment 28. The roofing panel support according to any one of embodiments 12 to 27, wherein the insulation is formed as coating that is adhered to a surface of the metal clip.

Embodiment 29. The roofing panel support according to any one of embodiments 12 to 27, wherein the insulation is formed as one or more sleeves that slips over a section of the metal clip. Embodiment 30. The roofing panel support according to any one of embodiments 12 to 29, wherein the insulation includes at least one of silicone, PVDF, PTFE and PVC. Embodiment 31. A roofing system comprising: a surface structure of a roof; a support structure including a first batten extending across the surface structure; a first roofing panel support according to any of embodiments 1 to 30 secured to the first batten; and a first roofing panel disposed on the bracket of the first roofing panel support and held by the first hook of the first roofing panel support.

Embodiment 32. The roofing system according to embodiment 31, wherein the first batten includes an upwardly extending flange that is received in a first slit in the first leg of the bracket of the first roofing panel support, and wherein a conductive malleable strip is interposed between the flange of the first batten and an edge of the first slit.

Embodiment 33. The roofing system according to embodiment 31 or embodiment 32, wherein the first roofing panel support is one of a plurality of roofing panel supports secured along the first batten.

Embodiment 34. The roofing system according to any one of embodiments 31 to 33, further comprising a second batten disposed above the first batten.

Embodiment 35. The roofing system according to embodiment 34, wherein a top end of the first roofing panel support is supported by the second batten.

Embodiment 36. The roofing system according to embodiment 34, further comprising a second roofing panel support secured to the second batten.

Embodiment 37. The roofing system according to embodiment 36, wherein a bottom end of the second roofing panel support overlaps the first roofing panel.

Embodiment 38. The roofing system according to any one of embodiments 31 to 37, wherein the first roofing panel is one of a plurality of roofing panels.

Embodiment 39. The roofing system according to embodiment 38, wherein at least one of the plurality of roofing panels is a solar roofing panel.

Embodiment 40. The roofing system according to embodiment 38, wherein at least one of the plurality of roofing panels is a non-solar roofing panel.

Embodiment 41. The roofing system according to embodiment 38, wherein the plurality of roofing panels includes a combination of both solar roofing panels and non-solar roofing panels.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A roofing panel support comprising:
a bracket including:
a support platform with a top end and a bottom end,
a first leg extending rearward from a first side of the support platform, the first leg including a first lower edge and a first slit extending upward into the first lower edge, and
a second leg extending rearward from a second side of the support platform, the second leg including a second lower edge and a second slit extending upward into the second lower edge;
a first hook coupled to the bracket and disposed below the bottom end of the support platform, the first hook including an upward facing opening configured to receive a bottom edge of the roofing panel; and
a conductive malleable strip configured to be received in the first slit so as to provide an electrical connection between the bracket and a support structure.

2. The roofing panel support according to claim 1, wherein an outer surface of the bracket is conductive.

3. The roofing panel support according to claim 2, wherein the bracket is formed of a metal material.

4. The roofing panel support according to claim 3, wherein the bracket is formed by a bent metal sheet.

5. The roofing panel support according to claim 1, wherein the conductive malleable strip is formed of a softer material than the bracket.

6. The roofing panel support according to claim 5, wherein the conductive malleable strip is formed of a material comprising aluminum, tin or lead.

7. The roofing panel support according to claim 1, wherein an edge of the first slit includes a row of teeth.

8. The roofing panel support according to claim 1, wherein the conductive malleable strip includes a folded structure with a front flap and a rear flap, and
wherein the conductive malleable strip is configured to surround a flange of the support structure such that the front flap is positioned against a front edge of the first slit and the rear flap is positioned against a rear edge of the first slit.

9. The roofing panel support according to claim 1, wherein the conductive malleable strip is plated on a flange of a batten.

10. The roofing panel support according to claim 1, wherein the conductive malleable strip is configured to extend to the second slit of the second leg.

11. The roofing panel support according to claim 1, wherein the first hook is formed by a metal clip secured to the bracket, the metal clip including:
an upper portion that extends behind the support platform, and
an exposed lower portion that extends below the bottom end of the bracket and includes the first hook.

12. The roofing panel support according to claim 11, further comprising insulation surrounding the exposed lower portion of the metal clip.

13. The roofing panel support according to claim 11, wherein the conductive malleable strip includes a forward extension configured to contact the metal clip.

14. A roofing panel support comprising:
a bracket including:
a support platform with a top end and a bottom end,
a first leg extending rearward from a first side of the support platform, and
a second leg extending rearward from a second side of the support platform;
a metal clip secured to the bracket, the metal clip including:
an upper portion that extends behind the support platform, and
an exposed lower portion that extends below the bottom end of the bracket and includes a first hook with an upward facing opening configured to receive a bottom edge of the roofing panel; and
insulation surrounding the exposed lower portion of the metal clip.

15. A roofing system comprising:
a surface structure of a roof;
a support structure including a first batten extending across the surface structure;
a first roofing panel support according to claim 1 secured to the first batten; and
a first roofing panel disposed on the bracket of the first roofing panel support and held by the first hook of the first roofing panel support.

16. The roofing panel support of claim 14, wherein an outer surface of the bracket is conductive.

17. The roofing panel support of claim 16, wherein the bracket is formed of a metal material.

18. The roofing panel support of claim 17, wherein the bracket is formed by a bent metal sheet.

19. The roofing panel support of claim 14, wherein the first leg includes a first lower edge and a first slit extending upward into the first lower edge, and wherein the second leg includes a second lower edge and a second slit extending upward into the second lower edge.

20. The roofing panel support of claim 14, wherein the exposed lower portion of the metal clip includes a second hook with an upward facing opening configured to receive the bottom edge of the roofing panel.
